(19) United States
(12) Patent Application Publication
(10) Pub. No.: US 2013/0141731 A1
(43) Pub. Date: Jun. 6, 2013

(54) OPTICAL INTERFERENCE APPARATUS

(71) Applicant: Chuan-Chung Chang, Hsinchu County (TW)

(72) Inventor: Chuan-Chung Chang, Hsinchu County (TW)

(73) Assignee: INDUSTRIAL TECHNOLOGY RESEARCH INSTITUTE, Hsinchu (TW)

(21) Appl. No.: 13/363,383

(22) Filed: Feb. 1, 2012

(30) Foreign Application Priority Data
Dec. 1, 2011 (TW) 100144170

(51) Int. Cl. G01B 9/02; G01J 3/45

(52) U.S. Cl. 356/451; 356/477; 356/479

(57) ABSTRACT

An optical interference apparatus of detecting an object is provided. The optical interference apparatus includes a light source capable of emitting a light beam, an optical coupler, a reflector, a first lens set and a light sensing unit. The optical coupler is capable of dividing the light beam into a measuring sub-light beam and a reference sub-light beam. The reflector reflects the reference sub-light beam. The first lens set includes a first lens. The measuring sub-light beam is transmitted to the object. The object reflects or scatters a part of the measuring sub-light beam back to the first lens. The first lens is capable of extending a depth of field of the first lens set. The light sensing unit is adapted to detect an interference signal formed by the reference sub-light beam and the measuring sub-light beam.

### CROSS-REFERENCE TO RELATED APPLICATION

This application claims the priority benefit of Taiwan application serial no. 100144170, filed on Dec. 1, 2011. The entirety of the above-mentioned patent application is hereby incorporated by reference herein and made a part of this specification.

### TECHNICAL FIELD

The disclosure relates to an optical interference apparatus.

### BACKGROUND

In recent years, as optical coherence tomography adopts infrared light that is not easily absorbed by biological tissues, optical coherence tomography can be effectively applied to detection of biological tissues, and has become an indispensable tool in the biomedical field, for example, for examination of retinopathy in ophthalmology. A conventional optical coherence tomography system is an interferometer having a low coherence light source. A tomographic image of an object to be measured at different penetration depths is obtained by an interference signal caused by the difference between optical distances of an optical path where the object to be measured is located and a reference path in the interferometer.

However, in the prior art, when the object to be measured deviates from an optimal imaging position, the transverse resolution of the tomographic image is limited by optical properties of an objective lens used in the optical coherence tomography system. In other words, in the case that the numerical aperture of the objective lens is fixed, when the object to be measured deviates from the optimal imaging position, the transverse resolution of the tomographic image significantly decreases, seriously affecting the quality of the tomographic image of the object to be measured.

### SUMMARY

An optical interference apparatus capable of detecting an object is introduced herein. The optical interference apparatus includes a light source capable of emitting a light beam, an optical coupler disposed in a path of the light beam, a reflector, a first lens set and a light sensing unit. The optical coupler is capable of dividing the light beam into a measuring sub-light beam and a reference sub-light beam. The reflector is disposed in a path of the reference sub-light beam to reflect the reference sub-light beam. The first lens set includes a first lens disposed in a path of the measuring sub-light beam. The measuring sub-light beam is transmitted to the object after passing through the first lens set. The object reflects or scatters a part of the measuring sub-light beam back to the first lens set. The first lens has a spherical aberration and is capable of extending a depth of field of the first lens set. The light sensing unit is disposed in the path of the reference sub-light beam reflected from the reflector and in the path of the measuring sub-light beam transmitted back from the object and passing through the first lens set, to detect an interference signal formed by the reference sub-light beam and the measuring sub-light beam.

Several exemplary embodiments accompanied with figures are described in detail below to further describe the disclosure in details.

### BRIEF DESCRIPTION OF THE DRAWINGS

The accompanying drawings are included to provide further understanding, and are incorporated in and constitute a part of this specification. The drawings illustrate exemplary embodiments and, together with the description, serve to explain the principles of the disclosure.

FIG. 1 is a schematic diagram illustrating an optical interference apparatus according to a first embodiment of the disclosure.

FIG. 2 is a schematic three-dimensional diagram illustrating a first lens of FIG. 1.

FIG. 3A shows a tomographic image signal of an object, which is obtained by using the optical interference apparatus according to the first embodiment of the disclosure.

FIG. 3B shows a tomographic image signal of an object, which is obtained by using an optical interference apparatus of a comparative example.

FIG. 4 is a schematic diagram illustrating an optical interference apparatus according to a second embodiment of the disclosure.

FIG. 5 shows a tomographic image signal of an object, which is obtained by using the optical interference apparatus according embodiment of the disclosure.

FIG. 6 is a schematic diagram illustrating an optical interference apparatus according to a third embodiment of the disclosure.

FIG. 7 is a schematic diagram illustrating an optical interference apparatus according to a fourth embodiment of the disclosure.

FIG. 8 is a schematic diagram illustrating an optical interference apparatus according to a fifth embodiment of the disclosure.

### DETAILED DESCRIPTION OF DISCLOSED EMBODIMENTS

An embodiment provides optical interference apparatus.

### First Embodiment

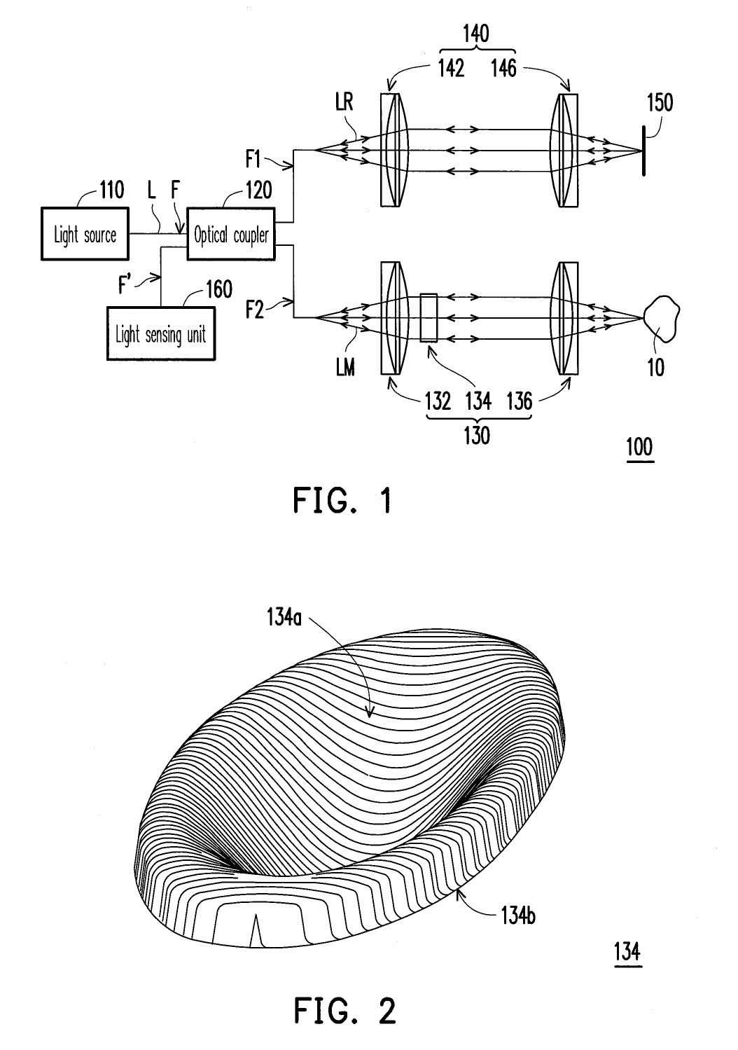

FIG. 1 is a schematic diagram illustrating an optical interference apparatus according to a first embodiment of the disclosure. Referring to FIG. 1, the optical interference apparatus 100 of this embodiment is used for detecting an object 10. The optical interference apparatus 100 of this embodiment includes a light source 110, an optical coupler 120, a first lens set 130, a reflector 150, and a light sensing unit 160. In this embodiment, the object 10 is, for example, a biological tissue, but the disclosure is not limited thereto.

The light source 110 of this embodiment is capable of emitting a light beam L. In this embodiment, the light beam L may be a low coherence beam. In other words, the light source of this embodiment has such a luminescence spectrum that the coherence length of the light beam L is finite. In particular, in this embodiment, the width of the luminescence spectrum of the light beam L emitted by the light source may range from ten nanometers to several hundred nanometers. Moreover, the light beam L of this embodiment may be a Gaussian beam. That is, the transverse electric field intensity distribution of the light beam L may be close to a Gaussian function. The light beam L of this embodiment has a central wavelength of λ, where λ may range from 700 nanometers to 1400 nanometers. In other words, in this embodiment, the main intensity of the light beam L may be distributed in the near infrared band, so as to increase the ability of the light beam L to penetrate the object 10 (for example, biological tissue).

The optical coupler 120 of this embodiment is disposed in a path of the light beam L, and is capable of dividing the light beam L into a reference sub-light beam LR and a measuring sub-light beam LM. In other words, the light beam L emitted by the light source 110 may be transmitted to the optical coupler 120 through an optical fiber F. After the optical coupler 120 divides the light beam L into the reference sub-light beam LR and the measuring sub-light beam LM, the optical coupler 120 may transmit the reference sub-light beam LR and the measuring sub-light beam LM by using two optical fibers F1 and F2 respectively.

The first lens set 130 of this embodiment is capable of receiving the measuring sub-light beam LM from the optical coupler 120. The first lens set 130 includes a first collimating lens 132, a first lens 134 and a first objective lens 136. The first collimating lens 132, the first lens 134 and the first objective lens 136 are disposed in a path of the measuring sub-light beam LM. The measuring sub-light beam LM may be transmitted to the object 10 after passing through the first collimating lens 132, the first lens 134 and the first objective lens 136 in sequence. The object 10 is capable of reflecting or scattering at least a part of the measuring sub-light beam LM back to the first lens set 130. In this embodiment, the measuring sub-light beam LM from the object 10 and passing through the first lens set 130 may be transmitted to the optical coupler 120 through the optical fiber F2.

FIG. 2 is a schematic three-dimensional diagram illustrating a surface profile of a first lens of FIG. 1. Referring to FIG. 1 and FIG. 2, the first lens 134 of this embodiment may be a plano-concave lens. A concave surface 134a of the first lens 134 may face the first objective lens 136, and a planar surface 134b of the first lens 134 may face the first collimating lens 132. However, the disclosure is not limited thereto, and in other embodiments, the first lens 134 may also be other forms of lenses.

In addition, it should be noted that, in FIG. 1, the first lens 134 is separated from the first collimating lens 132 and the first objective lens 136. However, the disclosure is not limited thereto, and in other embodiments, the first lens 134 may be integrated with the first collimating lens 132 or the first objective lens 136. Alternatively, the first lens 134, the first collimating lens 132 and the first objective lens 136 may be integrated into one optical element.

The optical interference apparatus 100 of this embodiment may further include a second lens set 140. The second lens set 140 includes a second collimating lens 142 and a second objective lens 146 disposed in a path of the reference sub-light beam LR. The reference sub-light beam LR passes through the second collimating lens 142 and the second objective lens 146 in sequence.

In this embodiment, the reference sub-light beam LR may be transmitted to the reflector 150 after passing through the second lens set 140. The reflector 150 is capable of reflecting the reference sub-light beam LR back to the second lens set 140, so that the reference sub-light beam LR is transmitted back to the optical coupler 120.

In this embodiment, the reference sub-light beam LR reflected by the reflector 150 may be transmitted back to the optical coupler 120 through the optical fiber F1. The light sensing unit 160 of this embodiment is disposed in the path of the reference sub-light beam LR from the reflector 150 and in the path of the measuring sub-light beam LM transmitted back from the object 10 and passing through the first lens 134, to detect an interference signal formed by the reference sub-light beam LR and the measuring sub-light beam LM. In other words, in this embodiment, the optical coupler 120 may combine the reference sub-light beam LR from the reflector 150 and the measuring sub-light beam LM transmitted back from the object 10 and passing through the first lens set 130, and transmit the reference sub-light beam LR and the measuring sub-light beam LM to the light sensing unit 160 through an optical fiber F′.

A user can obtain a tomographic image of the object 10 through the interference signal formed by the reference sub-light beam LR and the measuring sub-light beam LM. For example, the optical interference apparatus 100 of this embodiment may be of a time domain type. The reflector 150 of this embodiment is capable of moving along the path of the reference sub-light beam LR. The light sensing unit 150 of this embodiment may be a photo-diode, a charge coupled device (CCD) or a complementary metal oxide semiconductor (CMOS) sensor. When an optical distance by which the measuring sub-light beam LM is reflected by an object at a particular penetration depth in the object 10 back to the light sensing unit 160 is equal to an optical distance by which the reference sub-light beam LR is reflected by the reflector 150 back to the light sensing unit 160, the light sensing unit 160 can detect an interference signal with maximum contrast. Therefore, the optical interference apparatus 100 of this embodiment can realize tomography by movement of the reflector 150. However, the disclosure is not limited thereto, and in other embodiments, the optical interference apparatus 100 may also be of a frequency domain type. In such embodiments, the light sensing unit 160 may be a spectrometer. A tomographic image of the object 10 may also be obtained by recording interference signals of difference wavelengths and in combination with a signal processing method such as Fourier transform.

It should be noted that, the first lens 134 of this embodiment has a spherical aberration to extend a depth of field of the first lens set 130. In other words, the first lens 134 is capable of increasing the depth of field of the first lens set 130. In this way, if the object 10 deviates from an optimal imaging position, the divergence of the measuring sub-light beam LM reflected by the object 10 does not easily increase with increasing deviation, thereby improving the transverse resolution of the tomographic image of the object 10.

Furthermore, in this embodiment, orders of spherical aberrations of the first lens 134 may be designed according to the condition that the incident light beam L is a Gaussian beam and a cut-off ratio of the width of the Gaussian beam to the system aperture, so as to optimize the performance of the optical interference apparatus 100. Specifically, in this embodiment, the spherical aberration of the first lens 134 includes at least one of all orders of spherical aberrations. In this embodiment, the spherical aberration of the first lens 134 may include a third-order spherical aberration and a fifth-order spherical aberration. An value of the third-order spherical aberration may fall within a range from 0.025λ to 5.000λ or from −5.000λ, to −0.025λ. An value of the fifth-order spherical aberration may fall within a range from 0.001λ to 5.000λ or from −5.000λ, to −0.001λ. Here, λ is the central wavelength of the light beam L.

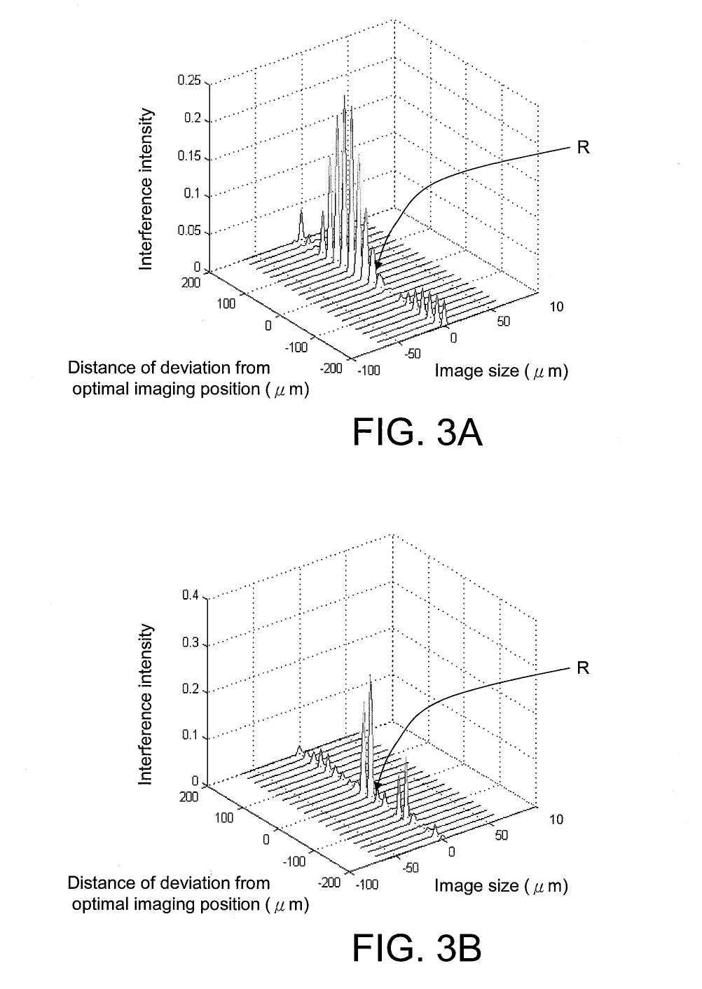

FIG. 3A shows a tomographic image signal of an object, which is obtained by using the optical interference apparatus according to the first embodiment of the disclosure. FIG. 3B shows a tomographic image signal of an object, which is obtained by using an optical interference apparatus of a comparative example. The difference between the optical interference apparatus 100 of this embodiment and the optical interference apparatus of the comparative example lies in that, the optical interference apparatus 100 of this embodiment further includes the first lens 134. It can be known by comparing FIG. 3A with FIG. 3B that, when the optical interference apparatus 100 includes the first lens 134, the optical interference apparatus 100 can obtain a tomographic image signal of the object with sufficient intensity and larger width in signal, even if the object 10 deviates from an optimal imaging position R. In other words, the first lens 134 can improve the transverse resolution of the tomographic image of the object 10.

### Second Embodiment

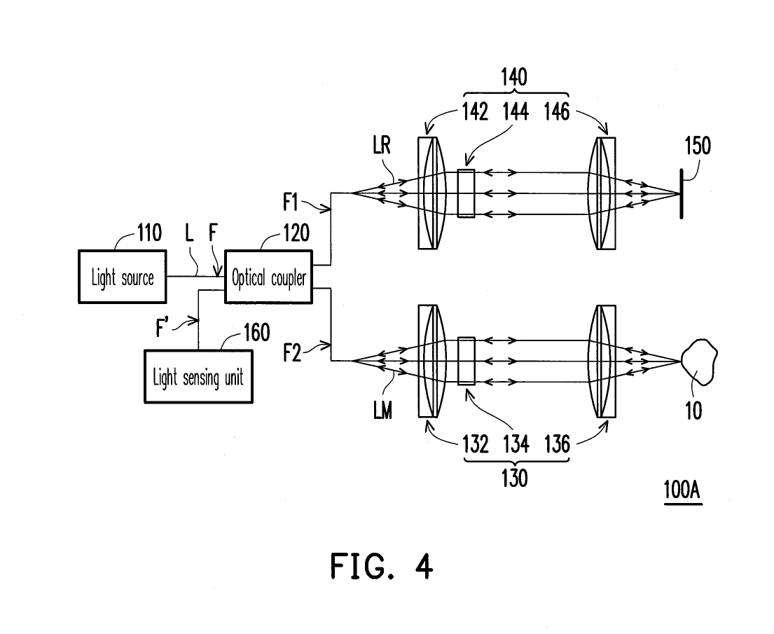

FIG. 4 is a schematic diagram illustrating an optical interference apparatus according to a second embodiment of the disclosure. Referring to FIG. 4, in the optical interference apparatus 100A of this embodiment, the second lens set 140 further includes a second lens 144. The second lens 144 includes at least one of all orders of spherical aberrations. The measuring sub-light beam LM passes through the first collimating lens 132, the first lens 134 and the first objective lens 136, and the reference sub-light beam LR passes through the second collimating lens 142, the second lens 144 and the second objective lens 146. The light intensity difference between the measuring sub-light beam LM and the reference sub-light beam LR transmitted back to the light sensing unit 160 is small, so that the interference signal received by the light sensing unit 160 has good contrast (that is, large signal-to-noise ratio). Thus, the performance of the optical interference apparatus 100A can be further improved.

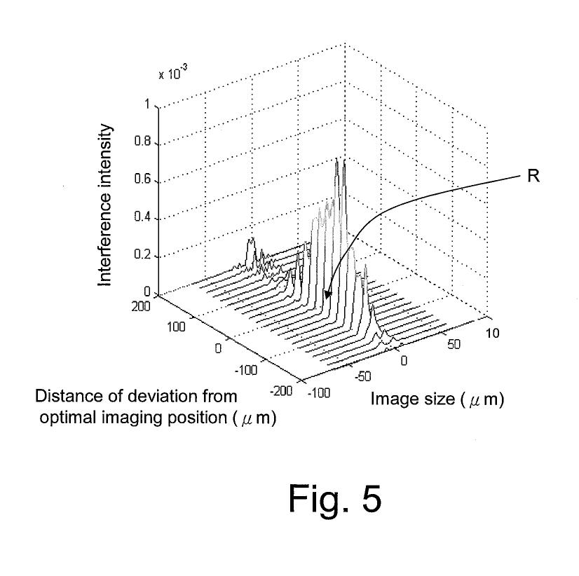

FIG. 5 shows a tomographic image signal of an object, which is obtained by using the optical interference apparatus according to the second embodiment of the disclosure. It can be known by comparing FIG. 3A with FIG. 5 that, the optical interference apparatus 100A of this embodiment can more reduce the variation of the contrast of the interference signal when the object deviates from the optimal imaging position. Moreover, the optical interference apparatus 100A of this embodiment when used in combination with a better sensitivity light sensing unit 160 can have similar effects and advantages to the optical interference apparatus 100 of the first embodiment.

### Third Embodiment

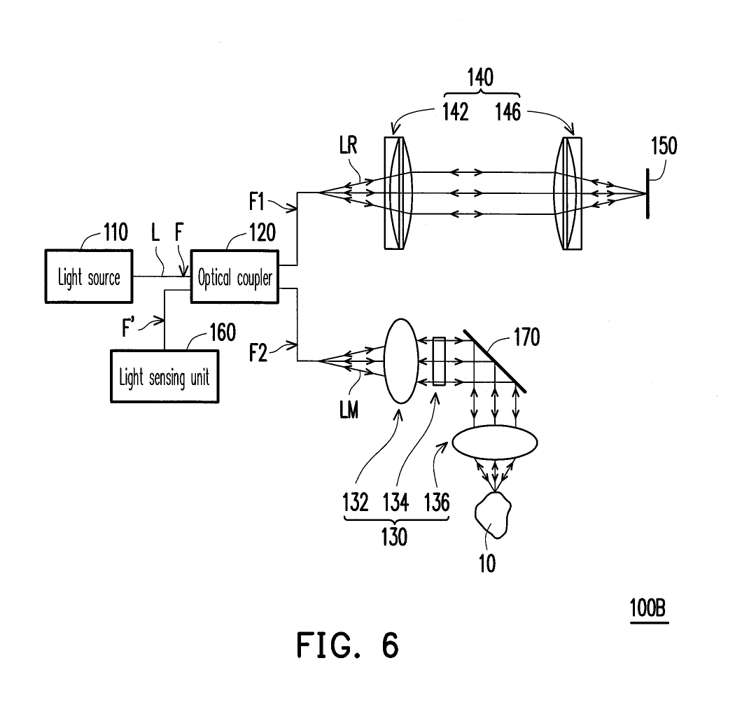

FIG. 6 is a schematic diagram illustrating an optical interference apparatus according to a third embodiment of the disclosure. Referring to FIG. 6, the optical interference apparatus 100B of this embodiment may further include a scanning reflector 170. The scanning reflector 170 is disposed in the path of the measuring sub-light beam LM, and located between the optical coupler 120 and the object 10. The scanning reflector 170 is capable of rotating to deflect a direction of travel of the measuring sub-light beam LM. In other words, the scanning reflector 170 is capable of enabling the measuring sub-light beam LM to scan different positions of the object 10.

### Fourth Embodiment

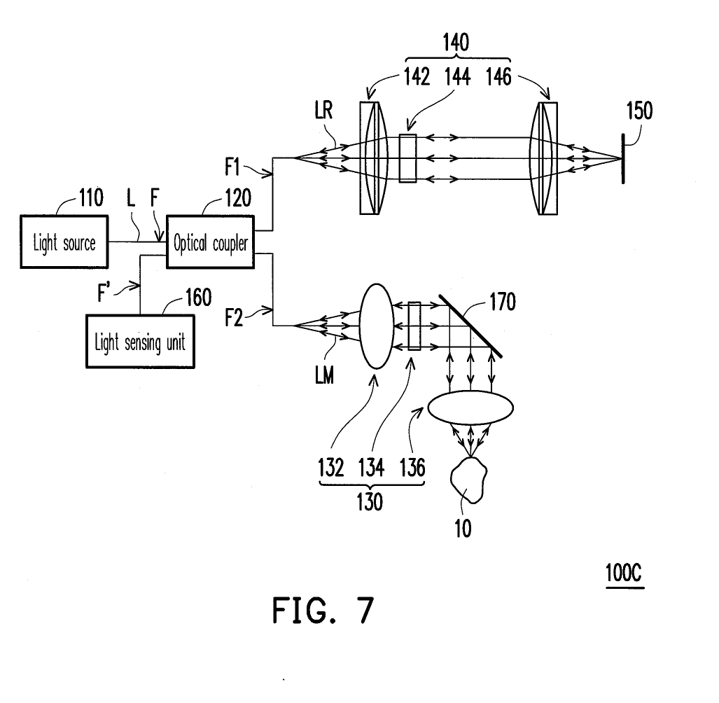

FIG. 7 is a schematic diagram illustrating an optical interference apparatus according to a fourth embodiment of the disclosure. Referring to FIG. 7 in the optical interference apparatus 100C of this embodiment, the second lens set 140 further includes a second spherical aberration lens 144. The second spherical aberration lens 144 includes at least one of all orders of spherical aberrations. The measuring sub-light beam LM passes through the first collimating lens 132, the first spherical aberration lens 134 and the first objective lens 136, and the reference sub-light beam LR passes through the second collimating lens 142, the second spherical aberration lens 144 and the second objective lens 146. The light intensity difference between the measuring sub-light beam LM and the reference sub-light beam LR transmitted back to the light sensing unit 160 is small, so that the interference signal received by the light sensing unit 160 has good contrast (that is, large signal-to-noise ratio). Thus, the performance of the optical interference apparatus 100C can be further improved.

### Fifth Embodiment

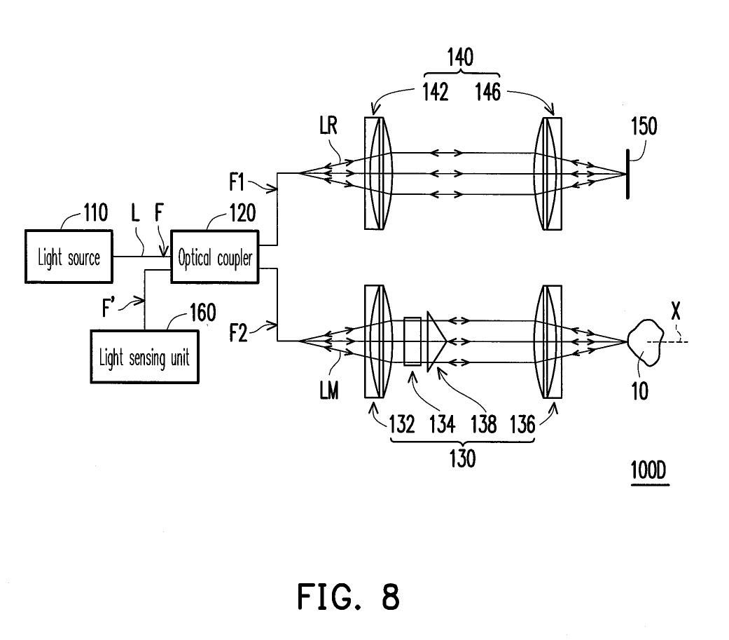

FIG. 8 is a schematic diagram illustrating an optical interference apparatus according to a fifth embodiment of the disclosure. Referring to FIG. 8, in the optical interference apparatus 100D of this embodiment, the first lens set 130 further includes a cone-shaped lens 138. The cone-shaped lens 138 is disposed in the path of the measuring sub-light beam LM and located between the first collimating lens 132 and the first objective lens 136. Under the action of the first lens 134 and the cone-shaped lens 138, the depth of field of the first lens set 130 can be further improved, thereby further improving the performance of the optical interference apparatus 100D.

Based on the above, in the optical interference apparatus according an embodiment of the disclosure, the depth of field of the first lens set can be increased by the spherical aberration, thereby improving the transverse resolution of the tomographic image of the object.

In the optical interference apparatus according to another embodiment of the disclosure, the second lens set also includes a spherical aberration similar to the first lens set. In other words, the measuring sub-light beam and the reference sub-light beam may respectively pass through the first lens set and the second lens set having similar optical effects. Therefore, the measuring sub-light beam and the reference sub-light beam transmitted back to the light sensing unit have similar light intensities, so that the interference signal received by the light sensing unit has good contrast (that is, large signal-to-noise ratio).

In the optical interference apparatus according to still another embodiment of the disclosure, the optical interference apparatus may further include a scanning reflector. The scanning reflector enables the measuring sub-light beam to scan every position of the object.

In the optical interference apparatus according to yet another embodiment of the disclosure, the first lens set may further include a cone-shaped lens. Under the action of the spherical aberration and the cone-shaped lens, the depth of field of the first lens set can be further increased, thereby further improving the performance of the optical interference apparatus.

It will be apparent to those skilled in the art that various modifications and variations can be made to the structure of the disclosed embodiments without departing from the scope or spirit of the disclosure. In view of the foregoing, it is intended that the disclosure cover modifications and variations of this disclosure provided they fall within the scope of the following claims and their equivalents.

What is claimed is:

1. An optical interference apparatus, capable of detecting an object, the optical interference apparatus comprising:
a light source, capable of emitting a light beam;
an optical coupler, disposed in a path of the light beam, and capable of dividing the light beam into a measuring sub-light beam and a reference sub-light beam;
a reflector, disposed in a path of the reference sub-light beam to reflect the reference sub-light beam;
a first lens set, comprising:
a first lens, disposed in a path of the measuring sub-light beam, wherein the measuring sub-light beam is transmitted to the object after passing through the first lens, at least a part of the measuring sub-light beam is transmitted back from the object to the first lens, and the first lens has a spherical aberration to extend a depth of field of the first lens set; and
a light sensing unit, disposed in the path of the reference sub-light beam from the reflector and in the path of the measuring sub-light beam from the object and passing through the first lens, to detect an interference signal formed by the reference sub-light beam and the measuring sub-light beam.

2. The optical interference apparatus according to claim 1, wherein the light beam is a Gaussian beam.

3. The optical interference apparatus according to claim 1, wherein the light beam is a low coherence beam.

4. The optical interference apparatus according to claim 1, wherein the spherical aberration comprises at least one of all orders of spherical aberrations.

5. The optical interference apparatus according to claim 4, wherein the spherical aberration comprises a third-order spherical aberration.

6. The optical interference apparatus according to claim 5, wherein the light beam has a central wavelength of λ, and an value of the third-order spherical aberration falls within a range from 0.025λ to 5.000λ or from −5.000λ to −0.025λ.

7. The optical interference apparatus according to claim 4, wherein the spherical aberration comprises a fifth-order spherical aberration.

8. The optical interference apparatus according to claim 7, wherein the light beam has a central wavelength of λ, and an value of the fifth-order spherical aberration falls within a range from 0.005λ to 5.000λ or from −5.000λ to −0.005λ.

9. The optical interference apparatus according to claim 1, wherein the first lens set further comprises a first collimating lens and a first objective lens, the measuring sub-light beam is transmitted to the first lens after passing through the first collimating lens, and the measuring sub-light beam is transmitted to the first objective lens after passing through the first lens.

10. The optical interference apparatus according to claim 9, wherein the first lens set further comprises a cone-shaped lens, disposed in the path of the measuring sub-light beam and located between the first collimating lens and the first objective lens.

11. The optical interference apparatus according to claim 1, further comprising a second lens set, wherein the second lens set comprises a second collimating lens and a second objective lens disposed in the path of the reference sub-light beam, and the reference sub-light beam is transmitted to the second objective lens after passing through the second collimating lens.

12. The optical interference apparatus according to claim 11, wherein the second lens set further comprises a second lens, located between the second collimating lens and the second objective lens.

13. The optical interference apparatus according to claim 1, further comprising a scanning reflector, disposed in the path of the measuring sub-light beam, located between the optical coupler and the object, and capable of rotating to deflect a direction of travel of the measuring sub-light beam.

14. The optical interference apparatus according to claim 13, wherein the first lens set further comprises a first collimating lens and a first objective lens, the measuring sub-light beam is transmitted to the first lens after passing through the first collimating lens, the measuring sub-light beam is transmitted to the first objective lens after passing through the first lens, and the scanning reflector is located between the first spherical aberration lens and the first objective lens.

15. The optical interference apparatus according to claim 1, wherein the first lens set further comprises a first collimating lens and a first objective lens, the measuring sub-light beam is transmitted to the first lens after passing through the first collimating lens, the measuring sub-light beam is transmitted to the first objective lens after passing through the first lens, and the first lens is bonded to the first collimating lens or the first objective lens.

16. The optical interference apparatus according to claim 1, wherein the reflector is capable of moving along the path of the reference sub-light beam.

17. The optical interference apparatus according to claim 16, wherein the light sensing unit is a photo-diode or a charge coupled device or a complementary metal oxide semiconductor sensor.

18. The optical interference apparatus according to claim 1, wherein the light sensing unit is a spectrometer.

19. The optical interference apparatus according to claim 1, wherein the reference sub-light beam from the reflector and the measuring sub-light beam from the object and passing through the first lens are transmitted to the optical coupler, and the optical coupler combines the reference sub-light beam from the reflector and the measuring sub-light beam from the object and passing through the first lens, so as to transmit the reference sub-light beam and the measuring sub-light beam to the light sensing unit.
